(19) United States
(12) Patent Application Publication
(10) Pub. No.: US 2006/0228517 A1
(43) Pub. Date: Oct. 12, 2006

(54) Isolation liner for protecting single and multi-surfaced material

(76) Inventor: Narayanan M. Subramanian, Marietta, GA (US)

Correspondence Address: NARAYANAN M. SUBRAMANIAN, 4251 CREEK HAVEN DR., MARIETTA, GA, 30062, US

(21) Appl. No.: 10/907,585

(22) Filed: Apr. 6, 2005

(51) Int. Cl. B32B 3/06; B32B 3/02; B32B 3/14

(52) U.S. Cl. 428/68; 428/77; 428/78; 428/101

(57) ABSTRACT

An isolation liner to protect single and multi-surfaced material from contamination, scratch etc. The isolation liner must be easy to remove from the material it is protecting while being cost effective to manufacture.

### FIELD OF INVENTION

The present invention relates to single and multi-surfaced, coated materials such as labels, contact sheets, double stick tapes and unmounted paintings and to single and multi-surfaced, uncoated materials such as Plexiglas, highly polished machined parts, top surface of mirrors etc. that need an isolation liner to protect the surface(s) from contamination and scratch.

### BACKGROUND OF THE INVENTION

Generally, there are two kinds of adhesive coated sheets, tapes and films (henceforth called film); the first kind is a single-surface adhesive coated film wherein one surface is coated with an adhesive that does not dry till it is applied to a work piece.

The second kind is a double-surface adhesive coated film wherein both the top and bottom surfaces of the film are coated with an adhesive that does not dry till it is applied to a work piece. The single-surface adhesive coated film typically requires that the adhesive coated surface be covered with an isolation liner to prevent the adhesive coated surface from sticking together with another part of the adhesive coated surface or with a non-adhesive surface when the film is rolled for packaging and storing, or, when the film is being prepared by the user for application onto a work piece. It also requires the isolation liner to prevent dirt and other contamination from sticking to the adhesive coating till the user is ready to use it. There are quite a few patents issued for this type of single surface adhesive coated film such as U.S. Pat. No. 5,662,976 issued to Ghanshyam H. Popat et al, U.S. Pat. No. 6,016,618 issued to Omar Attia et al and U.S. Pat. No. 6,863,311 issued to James M. Riley. In all of them, the isolation liner is the same size as the adhesive coated film. The adhesive coated film is preformed into smaller, pre-defined size labels. So to separate the label from the isolation liner, the label-liner combination is bent at the preformed cut so that the label will separate. But if the user wants to use a non-preformed sheet and cut it to the size he/she wants, then it is difficult to remove the isolation liner. This is seen in case of contact sheets, where it is sold as rolls.

The double-surface adhesive coated film typically requires that at least one adhesive coated surface of the film be covered with an isolation liner to prevent the first adhesive coated surface from sticking together with the second adhesive coated surface when the film is rolled for packaging and storing. If the film cannot be rolled, for example a Plexiglas sheet, then all the surfaces that should be protected from contamination and/or scratch should be covered with isolation liners. When the user is ready to use the conventional single-surface adhesive coated film such as shelf liners and contact sheets, the user will have to first cut the sheet to size and then remove the isolation liner covering the adhesive coated surface. The process of removing the isolation liner is extremely difficult and takes a lot of time and effort. When the user is ready to use the conventional double-surface adhesive coated film, the user has to apply the exposed adhesive coated surface that comes without the isolation liner onto a work piece, cut the adhesive coated film to size and then remove the isolation liner to expose the second adhesive coated surface to apply onto a second work piece. Again, the process of removing the isolation liner is extremely difficult and takes a lot of time and effort. This is true for other coated and uncoated, single and multi-surfaced materials that must be protected from contamination and scratch with isolation liners

### SUMMARY OF THE INVENTION

The primary objective of the present invention is to provide an improved isolation liner that is easy to remove from any surface requiring an isolation liner to protect it from contamination, scratch etc. The surface could be a coated surface such as contact sheet, painting or double stick tape or an uncoated surface such as a highly polished mirror etc.

Another objective of the present invention is to make the manufacture of the improved isolation liner cost effective for the manufacturer to adopt it.

The foregoing objectives of the present invention are attained by having the width of the isolation liner more than the width of the surface it is covering (such as coated and uncoated single-surfaced and multi-surfaced materials) and by placing the isolation liner on the surface to be protected such that, for a rolled film, the isolation liner covers the surface to be protected completely and the excess width projects out axially from one or both sides of the rolled film. The user can use this excess width of the liner that is protruding out, to grab the liner with the fingers, finger nails or an instrument and peel it from the surface being protected.

For rigid materials that cannot be rolled, for which an isolation liner is used to protect one or more surfaces, the isolation liner is made to be wider than the surface it is covering so that the excess isolation liner protrudes out from one or more sides of the material it is protecting. Again, the user can use this excess liner that is protruding out, to grab the liner with the fingers, finger nails or an instrument and peel it from the surface being protected.

### BRIEF DESCRIPTION OF THE DRAWINGS

FIG. 1 is a roll of single-surface adhesive coated film of the current state of the art, with a length of film unwound from the roll and the isolation liner separated from the adhesive coated surface. In this, the length and width of the isolation liner are the same as those of the adhesive coated surface.

FIG. 2 is a roll of double-surface adhesive coated film of the current state of the art, with a length of film unwound from the roll and the isolation liner separated from one of the adhesive coated surfaces it is covering. In this, the length and width of the isolation liner are the same as those of the adhesive coated surface.

FIG. 3 is a roll of single-surface adhesive coated film of the preferred embodiment of the present invention, with a length of film unwound from the roll and the isolation liner separated from the adhesive coated surface. The isolation liner width is more than the width of the adhesive coated film and extends axially on both sides of the adhesive coated film.

FIG. 4 is a roll of single-surface adhesive coated film of another preferred embodiment of the present invention, with a length of film unwound from the roll and the isolation liner separated from the adhesive coated surface. The isolation liner width is more than the width of the adhesive coated film and extends axially on only one side of the adhesive coated film.

FIG. 5 is a roll of double-surface adhesive coated film of the preferred embodiment of the present invention, with a length of film unwound from the roll and the isolation liner separated from one of the adhesive coated surfaces it is covering. The isolation liner width is more than the width of the adhesive coated film and extends axially on both sides of the adhesive coated film.

FIG. 6 is a roll of double-surface adhesive coated film of another preferred embodiment of the present invention, with a length of film unwound from the roll and the isolation liner separated from one of the adhesive coated surfaces it is covering. The isolation liner width is more than the width of the adhesive coated film and extends axially on only one side of the adhesive coated film.

FIG. 7 is a rigid, single-surface adhesive coated film of the preferred embodiment of the present invention, with an isolation liner covering the adhesive coated surface of the rigid film. The isolation liner has been peeled a little bit from the adhesive coated surface of the rigid film. The length and width of the isolation liner are more than the length and width of the adhesive coated rigid film and extends on all four sides of the adhesive coated rigid film.

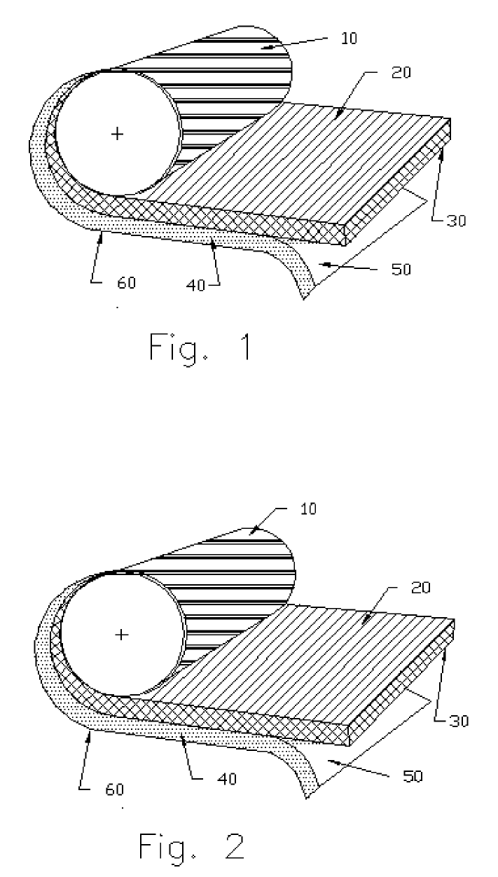

The numbering is kept consistent across FIG. 1 through FIG. 7 for clarity.

### DETAILED DESCRIPTION OF THE INVENTION

FIG. 1 refers to the current state of the art for a single-surface adhesive coated roll of film, marked 10. The film has a first non-adhesive surface 20 and a second adhesive coated surface 30. An isolation liner, 40, has a first isolation surface 50 and a second isolation surface 60. The isolation surface 50, is in contact with the adhesive coated surface 30 of the film and protects surface 30 from contamination till such time the user peels the isolation liner from the adhesive coated film to apply the adhesive coated surface onto a work piece. Here, the length and width of the isolation liner are the same as those of the adhesive coated film.

Referring to FIG. 2, a double-surface adhesive coated film, marked 10, of the current state of the art is displayed. It has a first adhesive coated surface 20 and a second adhesive coated surface 30. An isolation liner, 40, has a first isolation surface 50 and a second isolation surface 60. The isolation surface 50, is in contact with the adhesive coated surface 30 of the film. When the film is rolled, surface 60 of the isolation liner comes in contact with the adhesive coated surface 20, thus protecting surface 20 from contamination or from bonding with surface 30. Thus, the first surface of the isolation liner is continually in contact with the second surface of the adhesive coated film. The second surface of the isolation liner comes in contact with the first surface of the adhesive coated film only when the film is kept in a rolled position as shown in FIG. 2. Here, the length and width of the isolation liner are the same as those of the adhesive coated film.

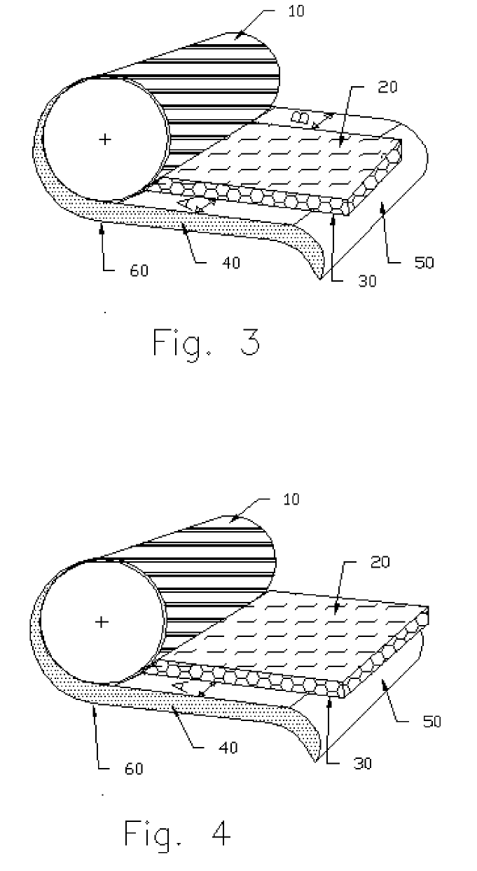

FIG. 3 is a preferred embodiment of the current invention for a single-surface adhesive coated film, marked 10. FIG. 4 is another preferred embodiment of the current invention for a single-surface adhesive coated film, marked 10. In both FIG. 3 and FIG. 4, the film has a first non-adhesive surface 20 and a second adhesive coated surface 30. It also has an isolation liner, 40, with a first isolation surface 50 and a second isolation surface 60. The isolation surface 50, is in contact with the adhesive coated surface 30 of the film and protects surface 30 from contamination till such time the isolation liner is removed for use. In FIG. 3, the isolation liner covers the adhesive coated surface completely and protrudes axially on both sides of the adhesive coated film, marked ‘A’ and ‘B’. Surfaces ‘A’ and ‘B’ are a part of liner 40. In FIG. 4, the isolation liner covers the adhesive coated surface completely and protrudes axially on only one side of the adhesive coated film, marked ‘A’. Surface ‘A’ is a part of liner 40. In FIG. 3, the user can grab the protruding part of the isolation liner, marked ‘A’ and/or ‘B’, to peel the isolation liner and expose the adhesive coated surface. In FIG. 4, the user can grab the protruding part of the isolation liner, marked ‘A’, to peel the isolation liner and expose the adhesive coated surface.

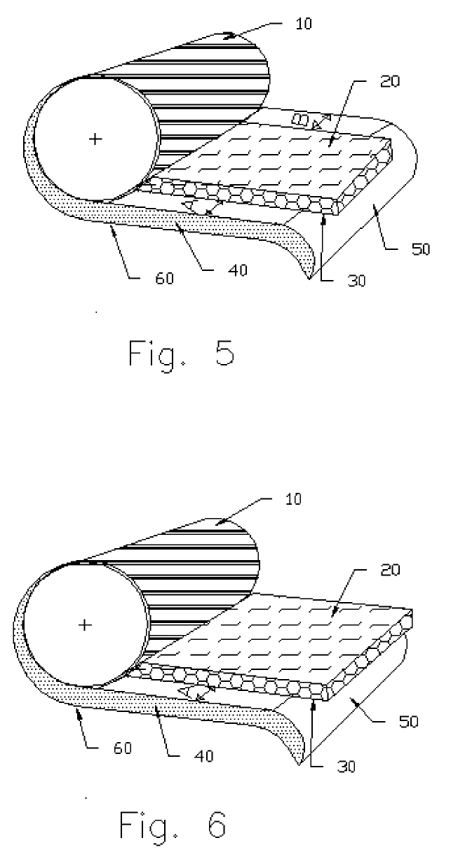

FIG. 5 is a preferred embodiment of the current invention for a double-surface adhesive coated film, marked 10. FIG. 6 is another preferred embodiment of the current invention for a double-surface adhesive coated film, marked 10. In both FIG. 5 and FIG. 6, the film has a first adhesive coated surface 20 and a second adhesive coated surface 30. It also has an isolation liner, 40, with a first isolation surface 50 and a second isolation surface 60. The isolation surface 50 is in contact with the second adhesive coated surface 30 of the film. When the film is rolled, isolation surface 60 comes in contact with the first adhesive coated surface 20, thus protecting surface 20 from contamination or from bonding with surface 30. Thus, the first surface of the isolation liner is continually in contact with the second adhesive coated surface of the film. The second surface of the isolation liner comes in contact with the first adhesive coated surface of the film only when the film is kept in a rolled position as shown in FIG. 5 and FIG. 6. In FIG. 5, the first surface of the isolation liner covers the second adhesive coated surface of the film completely and protrudes axially on both sides of the adhesive coated film, marked ‘A’ and ‘B’. Surfaces ‘A’ and ‘B’ are a part of isolation liner 40. In FIG. 6, the first surface of the isolation liner covers the second adhesive coated surface completely and protrudes axially on only one side of the adhesive coated film, marked ‘A’. Surface ‘A’ is a part of isolation liner 40. In FIG. 5, the user can grab the protruding part of the isolation liner, marked ‘A’ and/or ‘B’, to peel the isolation liner and expose the second adhesive coated surface. In FIG. 6, the user can grab the protruding part of the isolation liner, marked ‘A’, to peel the isolation liner and expose the second adhesive coated surface.

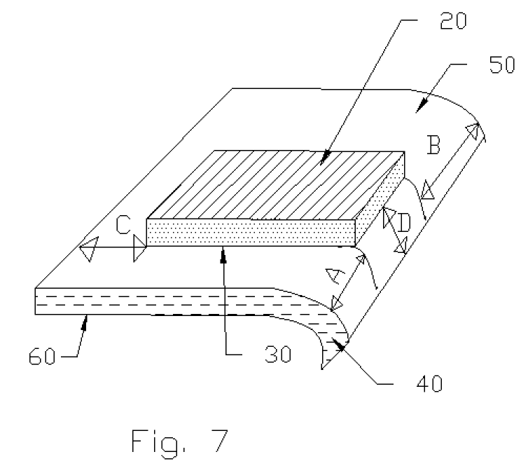

FIG. 7 is a preferred embodiment of the current invention for a single-surface adhesive coated rigid film that cannot be rolled. In this, the film has a first non-adhesive surface 20 and a second adhesive coated surface 30. It also has an isolation liner, 40, with a first isolation surface 50 and a second isolation surface 60. The isolation surface 50, is in contact with the adhesive coated surface 30 of the rigid film and protects surface 30 from contamination till such time the isolation liner is removed. The isolation liner covers the adhesive coated surface completely and protrudes on all sides of the adhesive coated rigid film, marked ‘A’, ‘B’, ‘C’ and ‘D’. Surfaces ‘A’, ‘B’, ‘C’ and ‘D’ are a part of isolation liner 40. In this, the user can grab any protruding part of the isolation liner, marked ‘A’, ‘B’, ‘C’ or ‘D’, to peel the isolation liner and expose the adhesive coated surface.

Even though the above description centers on isolation liners for single-surface and double-surface adhesive coated films, it should be construed that the current invention of an isolation liner is true for any number of surfaces that should be protected from contamination or scratch with an isolation liner.

What is claimed is:

1. An isolation liner made of material that is non-bonding with the surface it is protecting.

2. An isolation liner of claim 1 wherein the said isolation liner width is greater than the width of the said surface being protected.

3. An isolation liner of claim 2 wherein the excess width of the said isolation liner extends axially on one side of the width of the said surface being protected and protrudes out beyond the said surface being protected.

4. An isolation liner of claim 2 wherein the excess width of the said isolation liner extends axially on both sides of the width of the said surface being protected and protrudes out beyond the said surface being protected.

5. An isolation liner of claim 4 wherein the excess width of the said isolation liner extends out equally on both sides of the said surface being protected.

6. An isolation liner of claim 4 wherein the excess width of the said isolation liner extends out unequally on both sides of the said surface being protected.

7. An isolation liner of claim 1 wherein the said isolation liner is larger than the said surface being protected.

8. An isolation liner of claim 7 wherein the excess area of the said isolation liner extends on one or more sides of the said surface being protected and protrudes out on one or more sides beyond the said surface being protected.
